(19) United States
(12) Patent Application Publication
(10) Pub. No.: US 2005/0094648 A1
(43) Pub. Date: May 5, 2005

(54) Video information stream distribution unit

(76) Inventors: Sebastiaan Antonius Fransiscus Arnoldus Van Den Heuvel, Eindoven (NL); Mark Henricus Verberkt, Eindhoven (NL); Leendert Teunis Rozendaal, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/504,753

(22) PCT Filed: Jan. 21, 2003
(86) PCT No.: PCT/IB03/00148

(30) Foreign Application Priority Data
Feb. 20, 2002 (EP) 02075684.7

(51) Int. Cl. H04L 12/56

(52) U.S. Cl. 370/395.64

(57) ABSTRACT

A video information stream distribution unit distributes streams such as MPEG streams that contain packets making up sub-streams. Each packet having an identification code that identifies the sub-stream to which the packet belongs. The stream also contains table information that relates programs to said identification codes. The distribution unit generates a new stream from a received stream. In the new stream selected packets from the received stream are copied that have identification codes related to a selected program. In the new stream the table information for the selected program is included with an increased repetition rate in comparison with an incoming repetition rate of the table information in the received stream, at least temporarily during an initial time interval following a change of selection of the selected program. Thus, latency involved with access to the new stream is reduced.

The invention relates to a video information stream distribution unit.

U.S. Pat. No. 6,078,594 describes a method of changing channels in a digital video and audio receiving system, in particular a system that uses the MPEG standard to encode the video and audio information. The MPEG video encoding standard provides for the transmission of video and audio information in a so-called transport stream, which is made up of successive packets of information that are successively needed to decode the video and audio information. The transport stream is capable of encoding a plurality of programs concurrently, each program containing its own video and audio information.

The transport stream is organized as a set of sub-streams, each for a different programs and different type of information, e.g. a video sub-stream or an audio sub-stream. Each packet is provided with an identification code, the so-called PID that identifies the sub-stream to which the packet belongs. The transport stream contains further packets that contain table information for relating different programs with sets of PID's to be able to decode the programs. Examples of such tables are the PMT (Program Map Table) that maps programs to PID's and the PAT (Program Association Table) that specifies the PID of the packets that contain the PMT. According to the MPEG standard these tables have to be transmitted at a certain minimum repetition rate. Typically tables are transmitted every 0.1 seconds.

The tables enable the decoding of programs from streams that contain a plurality of concurrent programs. A viewer can select the program that he or she wants to view. This selection is communicated to a decoding device which selects the packets belonging to the selected program and decodes the video and audio information from the selected packets.

When an MPEG transport stream contains a plurality of programs it takes up a considerable amount of bandwidth. In broadcast systems, such as cable TV systems, this is well justified, because broadcast systems supply the transport stream to many viewers in parallel. However, when such a broadcast stream has reached the home of a user, this bandwidth use becomes needlessly cumbersome, because it may consume bandwidth in an in-home network for programs that are not viewed in the in home network. Therefore it is desirable to provide a gateway between the broadcast medium (cable network, satellite transmission band) and the in-home medium (for example a IEEE 1394 standard bus), so that the gateway removes superfluous programs from the transport stream.

The gateway is informed of the programs that are used in the in home network (e.g. for viewing or recording). The gateway receives a transport form outside stream and generates a transport stream for transmission over the in-home medium. The generated transport stream contains copies of packets from the received transport stream. The gateway selectively copies only those packets from the received transport stream that have PID's corresponding to the selected programs. In addition the gateway inserts adapted tables among the copied packets, to account for the fact that packets for some programs have been omitted in the generated transport stream.

When a viewer wants to change the selected program the decoding device has to select different packets and decode the video and audio information from those packets. Generally a certain amount of time, called the latency, is needed after such a change before decoded video and or audio information can be output to the viewer. The latency arises from an accumulation of different set-up times. This latency is disturbing for the viewer and therefore it is desirable to minimize the latency. U.S. Pat. No. 6,078,594 describes a method of reducing the latency when the viewer selects a different channel. Various mechanisms are described for this purpose, but these do not relate specifically to a gateway.

Amongst others it is an object of the invention to reduce latency when a change of selection of program is made.

Amongst others it is an object of the invention to make use of a gateway to reduce the latency when a change of selection of program is made.

The invention provides for a video information stream distribution unit according to Claim 1. The video information stream distribution unit may be a gateway apparatus for interfacing between two separate media, such as an in-home network and a broadcast medium, but the video information stream distribution unit may also input and output streams in the same medium. The video information stream distribution unit copies packets for a selected program from an incoming stream into a generated stream. According to the invention, the video information stream distribution unit enables devices that receive the generated stream to reduce latency, because the video information stream distribution unit transmits the tables that are needed to access packets with video and/or audio information at a higher repetition rate than their repetition rate in the incoming stream, at least initially after a change of the selected program. After the change of the selected program any receiving device has to access the tables before the packets with audio and/or video information can be accessed. Thus, the delay until the device accesses the table accumulates with other delays during a change of the selected program. By transmitting the tables at a higher repetition rate immediately after the change this delay is reduced. Later on the repetition rate may be lowered to the minimum prescribed for example in the MPEG standard.

In case of MPEG signals the invention may be applied to the PAT as well as the PMT. Since the receiving device has to access these tables sequentially, an increase in the repetition rate of both tables will have a cumulative effect on the latency.

The MPEG standards provides for encoding of video frames in terms of I frames, B-frames and P-frames. The I-frames are encoded independent of other frames, the B-frames and P-frames are encoded as changes to other frames, such as I-frames. In an embodiment of the video information stream distribution unit according to the invention The video information stream distribution unit does not copy (packets with) B-frames and P-frames from the received stream into the transmitted stream after a change of the selected program until (a packet with) an I frame has been copied. Thus, bandwidth is vacated for transmitting the additional tables. After the I frame the B-frames and P-frames may be copied and the repetition rate of the table may be reduced so as to avoid using an excess of bandwidth. Of course this way of providing additional bandwidth is not-limited to MPEG streams, but may be applied to any type of video stream that encodes some frames are encoded independent of other frames, and some frames as changes to other frames.

Preferably, the video information stream distribution unit derives the information in the tables at least partly from the incoming streams. For example the PID number of the selected program may be derived from the PMT of the received stream for use in the PMT of the generated stream. When the change of the selected program involves a change from one program to another in the same received stream the video information stream distribution unit preferably uses information from a PMT received prior to the change for this purpose. Thus, a minimum of delay occurs before the video information stream distribution unit van start transmitting tables.

When the change of the selected program involves a change from a program in one transport stream to a program in another transport stream the video information stream distribution unit has to access that other transport stream to generate the table.

In an embodiment the video information stream distribution unit contains a plurality of stream receiving units, a first one of the stream receiving units being used to receive the received stream from which the packets are copied and a second one of the stream receiving units being used to receive another stream concurrently, to extract table information from that other stream for use to generate table information upon a change of selection to a program in that other stream. Thus, the latency can be reduced also if the viewer switches to a program from a different stream. Some mechanism may be used to predict the next stream, so that the second one of the stream receiving unit can be made to receive a predicted next stream.

These and other objects and advantageous aspects of the video information stream distribution unit and method of generating a video information stream will be described in more detail using the following figures:

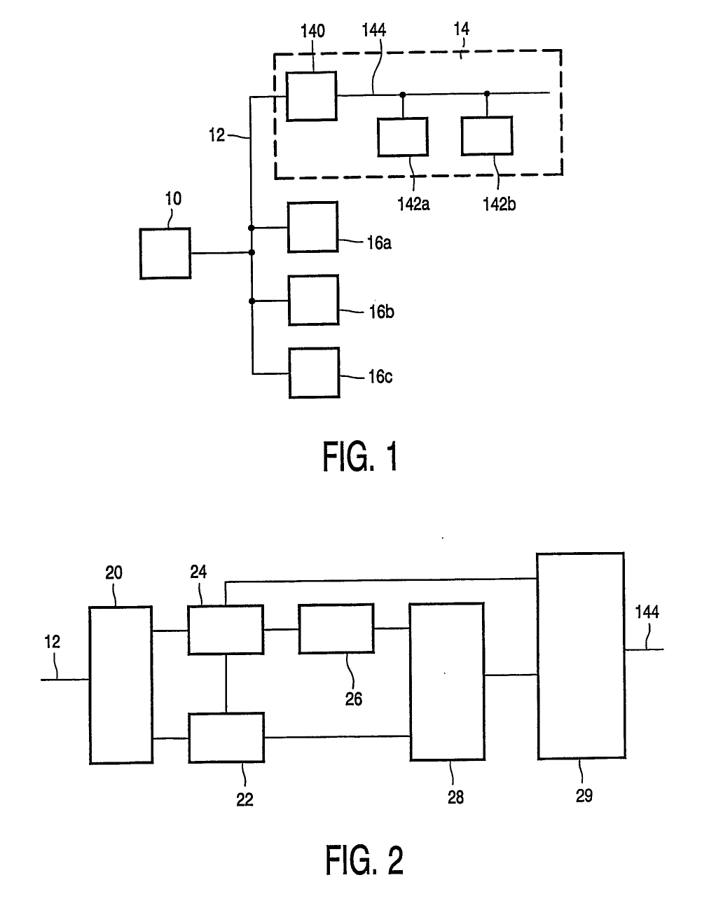

FIG. 1 shows a video information stream distribution system;

FIG. 2 shows a video information stream distribution unit;

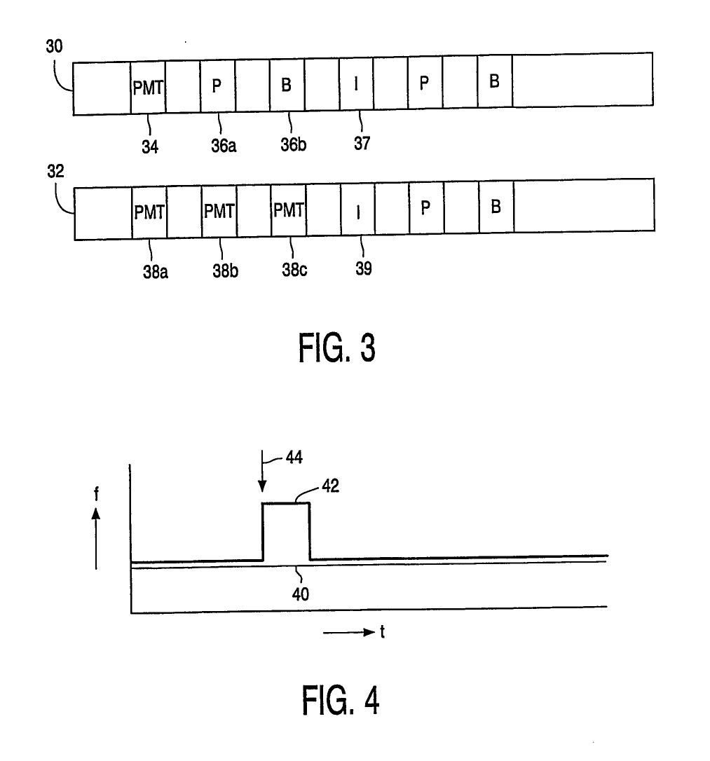

FIG. 3 shows video information streams;

FIG. 4 shows a graph of frequencies of packets with table information;

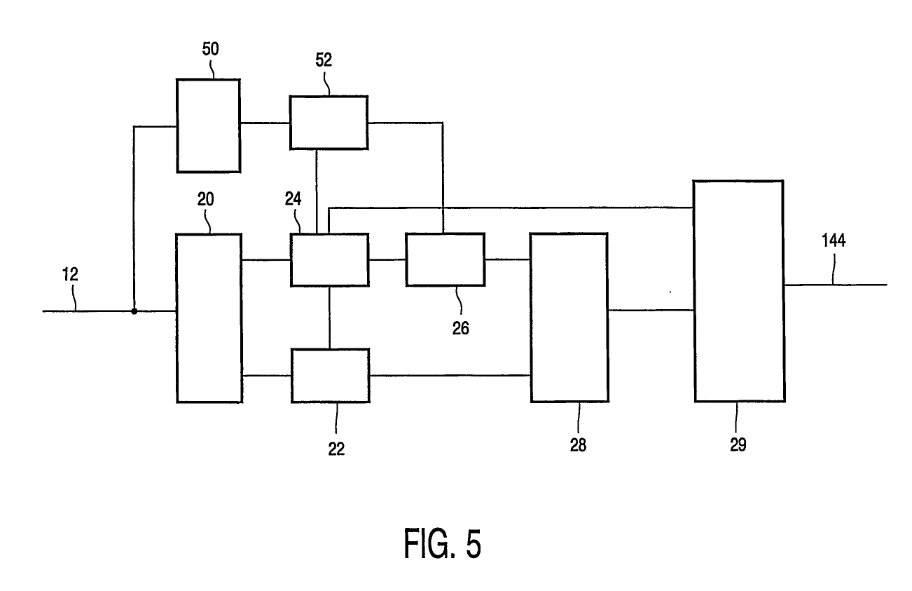

FIG. 5 shows a video information stream distribution unit.

FIG. 1 shows a video information stream distribution system, containing an original source apparatus 10, a first medium 12, an in-home system 14 and a number of receivers 16a-c. The original source apparatus 10 is coupled to the in-home system 14 and the receivers 16a-c via first medium 12. The in-home system contains a gateway 140, in-home receivers 142a,b and a second medium 144. The gateway 140 is coupled to the in-home receivers 142a,b via the second medium. Although the words “in-home system” has been used referring to the most usual application of the system, it will be appreciated that the invention is not specifically limited to use in homes.

FIG. 2 shows a gateway, containing a stream demultiplexer 20, a packet filter 22, a table processor 24, a table generator 26, a multiplexer 28 and a medium interface 29. The first medium 12 is coupled to an input of demultiplexer 20. Demultiplexer 20 has outputs coupled to packet filter 22 and table processor 24. Table processor has a command input coupled to medium interface 29 and an output coupled to table generator 26. Table generator 26 has an output coupled to multiplexer 28, which has an output coupled to medium interface 29. Medium interface 29 is coupled to second medium 144.

First medium 12 is for example a cable TV network, the original source apparatus being a cable head end. Alternatively, first medium 12 may be an electromagnetic field in free space, the original source being a broadcast transmitter or a satellite for example. Second medium 144 is for example an in-home bus, such as an IEEE P1394 bus (this bus uses separate connections to different apparatuses 142a,b, but functionally the apparatuses are all connected in common). Such a bus is typically provided in a private home and connects a number of information processing devices, including video receivers 142a,b, such as television sets, recording devices, PC's etc.

In operation, original source apparatus 10 broadcasts one or more transport streams to the in-home system 14 and receivers 16a-c. An MPEG coded transport stream will be used to describe operation of the invention by way of example, but it should be appreciated that the invention is not limited to such a stream. An MPEG stream may be used to transmit a plurality of “programs”. As used herein a program is a bundle of information sub-streams that may be rendered in combination. As such the word “program” applies to a conventional television channel as well as to delimited sections of information broadcast in a television channel, such as a commercial or a report of a sports game.

The sub-streams of a number of programs may be transmitted together in an MPEG transport stream. The information of each sub-stream is transmitted in packets with PID's (Program Identification) characteristic of the sub-stream. In addition the MPEG transport stream contains packets that contain table information for such tables as the PMT (Program Mapping Table) that maps Programs to PID's and the PAT that specifies the PID of the packets that contain the PMT. According to the MPEG standard this table information is regularly repeated, typically every 0.1 second so as to allow viewer that tune in to a program to start receiving the program soon after tuning into it.

Receivers 16a-c may receive the one or more transport streams from original source apparatus 10, select a program and render the program for “consumption” by a human user.

In home system 14 may be used to distribute information from the transport streams to various apparatuses 142a,b over an in-home medium. It is desirable that the in-home system 14 uses bandwidth for transmission of the information via second medium 144 more economically than bandwidth is used in first medium 12, because there is generally less bandwidth available in second medium 144 and because second medium 144 may have to be shared with other information streams.

Gateway 140 passes only part of the information from the one or more transport from first medium 12 to second medium 144. Typically, demultiplexer 20 supplies table information from a received transport stream to table processor 24. Table processor 24 receives information from second medium 144 that indicates which programs are needed on second medium 144, for example in the form of selection commands given by the viewer or commands from recording devices etc. Table processor 24 processes the table information received from demultiplexer 20 to determine the PID's corresponding to the selected program. Table processor 24 feeds these PID's to packet filter 22 which selectively passes packets with those PID's to multiplexer 28. Table processor 24 also commands table generator 26 to generate packets with table information describing these PID's. Table generator 26 feeds the generated packets to multiplexer 28. Multiplexer 28 multiplexes the filtered packets and the generated packets and passes them to the second medium 144 via medium interface 29.

FIG. 3 illustrates a number of aspects of time segment of a transport stream 30 received from first medium 12. The segment of the stream is symbolized as a bar 30, with packets indicated as blocks 34, 36a,b, 37 in the bar 30 at positions increasingly to the right as the packets are transmitted later. By way of example a packet 34 containing PMT information is shown, as well as a number of packets 36a,b, 37 that contain image frame information. By way of example one packet 37 contains I frame information and other packets contain P-frame and B-frame information (although san I, P, B is inserted in FIG. 3 to identify these packets 37, 39, it shall be understood there need not be a one to one correspondence between packets and frames: packets with I-frame, B-frame or P-frame information may contain other information, and information about I, B or P frames may be distributed over more than one packet). Generally speaking packets with all these kinds of information occur frequently repeated throughout the stream 30. Only some of these packets are illustrated explicitly. I frames, B frames and P-frames may be transmitted for a number of different programs in the same stream.

FIG. 3 also shows a transport stream 32 generated by gateway 140 for transmission via second medium 144. In principle this transport stream is similar to the transport stream 30 received from first medium 12, except that it generally only contains packets with frame information for a selected program. Packets for other programs generally are not contained in the generated stream 32.

Table processor 24 controls the frequency with which table generator 26 generates packets with table information. Table processor 24 ensures that at least initially after a change of the selected program packets with table information are transmitted more frequently over the second medium 144 than over the first medium 12.

FIG. 4 illustrates the frequency of packets with table information. Frequency “f” of packets with table information is plotted vertically as a function of time “t” horizontally. Two graphs 40, 42, are shown, a first graph 40 showing the frequency of packets containing table information in the received stream from first medium 12 and second graph 42 showing the frequency of packets containing table information in the generated stream transmitted to second medium 144. A time point 44 is indicated at which table processor 24 receives a signal to change the selected stream. After this time point the frequency 42 of packets containing table information in the generated stream transmitted to second medium 144 is increased temporarily. This decreases the time interval needed by any one of receivers 142a,b to start producing decoded video data, because the table information can be accessed faster, even if the receiver 142a,b cannot process the first transmitted table information. After an initial time interval with an increased frequency 42, table generator 26 may lower the frequency, but this is not necessary: without deviating from the invention the frequency of table information may remain higher than in the received stream. However, the reduction in latency between a change of the selected program and the start of rendering of that program becomes relatively smaller (relatively: reduction of latency divided by latency) and therefore less perceptible to the user when the additional table information is transmitted longer after the change of selected program. Therefore, the frequency of table information may be reduced as time progresses after the change of the selected program to free bandwidth. (Although, for the sake of clarity, FIG. 4 shows a slight difference between the frequencies after the initial larger difference, the frequencies are preferably the same after the initial larger difference).

FIG. 3 shows the generated stream 32 containing packets 38a-c with table information at a higher repetition rate than packets 34 with table information in the received stream 30. Although only PMT packets are shown it will be understood that the invention may be applied to PAT packets as well and preferably to both PMT and PAT packets and other packets that are needed before a program can be decoded properly in order to reduce the latency upon a change of the selected program.

In an embodiment table processor 24 also inspects received packets 36a,b, 37 that contain video information for the selected stream. Table processor 24 determines for each such packet whether it contains I-frame information or not. After a time point 44 where the selection of the program is changed table processor 24 commands packet filter 22 to block packets 36a,b with video information from the selected stream if the packets 36a,b that do not contain I frame information until a first packet 37 with I frame information has been received. The latter packet 37 and subsequent packets with video information of any type are passed to second medium 144. The vacated bandwidth is used to transmit additional packets 38b,c with table information to second medium 144.

FIG. 3 illustrates this as well: packets 36a,b with B-frame and P-frame information have been suppressed from generated stream 32. Of course, it may not be necessary to vacated bandwidth. When the second medium 144 is a P1394 bus for example, only certain predetermined amounts of bandwidth may be reserved for a transport stream. As a result, more bandwidth is usually reserved in the second medium than actually needed for the relevant part of the original transport stream. This bandwidth may be used to provide the table information at a higher repetition rate.

In principle table processor 24 gathers table information for the plurality of programs from the transport stream that contains the currently selected program. When a change of the selected program results in selection of another program in the same transport stream, table generator uses the table information gather before the change of the selected program to control filtering of packets and to supply PID information to table generator 26. Thus, table generator 26 does not need to wait for a first packet with table information after the change of the selected program. Table generator 26 generates a new packet with table information even before that first packet is received.

FIG. 5 shows a further embodiment of gateway 140. In comparison with FIG. 2 an additional stream receiver 50 and table processor 52 have been added. Additional receiver 50 has an input coupled to first medium 12 and an output coupled to additional table processor 52, which has an output coupled to table generator 26.

In operation additional stream receiver 50 and table processor 52 provide a look-ahead function, gathering table information from one or more streams that are not currently received by table processor 24. Upon a change of the selected program to a program from a different stream table generator 26 reads table information for the newly selected program from additional table processor 52. Thus, table generator 26 does not need to wait for a first packet with table information after the change of the selected program. Table generator 26 generates a new packet with table information even before that first packet is received.

Additional stream receiver 50 and table processor 52 may use any mechanism to promote that relevant table information is available. For example additional stream receiver 50 and table processor 52 may periodically scan through a number of different transport streams to gather and store recent table information from these streams for use by table generator 26 after a change of the selected program. Alternatively, additional stream receiver 50 and table processor 52 may predict a transport stream from which a next selected program will be derived and store table information from the predicted program. For example, zapping users often scan programs in a fixed sequence. By memorizing this sequence additional stream receiver 50 and table processor 52 can predict from the position of the current program in the sequence what the next program will be. Also zapping users often switch back repeatedly to the same program. This same program can therefore be used as a prediction. Thus, if the next program has been predicted correctly the latency after the change of program is reduced.

It will be appreciated that the preceding description merely serves to illustrate an implementation of the invention. Many alternative implementations are possible. For example, the invention is by no means limited to the architectures shown in FIGS. 2 and 5. The various functional blocks shown in these figures may in fact be combined to a greater or lesser extent or some or all of them may be implemented using different program segments executed on a computer. The functional blocks may also be combined with other functional blocks (not shown) used for handling transport streams. Also, although the invention has been illustrated using separate media 12, 144, gateway 140 may in fact apply the generated transport stream to the same medium 12 from which the received transport stream was received. Neither is the invention limited to MPEG streams.

1. A video information stream distribution unit, for distributing streams (30, 32) of a type that contains repeated table information (34, 38a-c) and sub-streams containing packets (I, P, B), each packet (I, P, B) having an identification code that identifies the sub-stream to which the packet (I, P, B) belongs, the table information (34, 38a-c) relating programs to said identification codes, the unit comprising
an input (12) for receiving a first stream (30) of said type;
an output (144) for transmitting a second stream (32) of said type;
a stream generator (140) arranged to generate the second stream (32), the stream generator (140) selectively copying packets (I, P, B) having identification codes related to a selected program from the first stream (30) to the second stream (32), the stream generator (140) generating the table information (38a-c) of the second stream for the selected program with an increased repetition rate in comparison with an incoming repetition rate of the table information (34) in the first stream (30), at least temporarily during an initial time interval following a change of selection of the selected program.

2. A video information stream distribution unit according to claim 1, wherein the streams (30, 32) of said type contain packets of a first packet type (I) that encode frames of video information independent of other frames of said video information and packets (P, B) of a second packet type that encode frames of video information in terms of modifications of frames of the first type (I), the stream generator being arranged to
detect whether packets are of the first type (I) or of the second type (P,B);
omit packets (36a,b) having identification codes related to the selected program when these packets are of the second type (P, B) and no packets of the first type (I) have yet been copied since said change of selection, the increased repetition rate of the table information (38a-c) of the second stream (32) using at least part of the bandwidth vacated by said omitting.

3. A video information stream distribution unit according to claim 1, wherein the stream (32) of said type contains further table information specifying an identification code or identification codes of packets that contain said table information, the stream generator generating the further table information of the second stream (32) for the selected program, increasing a repetition rate of the further table information of the second stream in comparison with a repetition rate of the further table information in the first stream (30), at least temporarily during the initial time interval.

4. A video information stream distribution unit according to claim 1, arranged to store table information from the first stream (30) containing identification codes of further programs from the first stream (30), the stream generator being arranged to generate the table information of the second stream (32) for the selected program using stored table information in the first stream (30) received before the change of the selected program, to generate the table information of the second stream (32) at least prior to receiving table information of the first stream (30) after the change of the selected program.

5. A video information stream distribution unit according to claim 1, comprising a further stream receiver (50, 52) arranged to store table information from one or more streams other than a stream received prior to the change of the selected program, the stream generator being arranged to generate the table information of the second stream for the selected program using stored table information for the one or more streams received before the change of the selected program, to generate the table information of the second stream prior to receiving table information of the first stream after the change of the selected program.

6. A method of distributing video information, for distributing streams of a type that contains repeated table information and substreams containing packets (I, P, B), each packet (I, P, B) having an identification code that identifies the sub-stream to which the packet (I, P, B) belongs, the table information relating programs to said identification codes, the method comprising
receiving a first stream (30) of said type;
transmitting a second stream (32) of said type;
generating the second stream (32), selectively copying packets having identification codes related to a selected program from the first stream (30) to the second stream (32), the table information of the second stream being generated for the selected program with an increased repetition rate in comparison with an incoming repetition rate of the table information in the first stream (30), at least temporarily during an initial time interval following a change of selection of the selected program.

7. A computer program product comprising instructions for instructing a computer to distribute video information, in streams of a type that contains repeated table information and packets (I, P, B) making up sub-streams, each packet (I, P, B) having an identification code that identifies the sub-stream to which the packet (I, P, B) belongs, the table information relating programs to said identification-codes, the instructions instructing the computer to
receive a first stream (30) of said type;
transmit a second stream (32) of said type;
generate the second stream (32), selectively copying packets having identification codes related to a selected program from the first stream (30) to the second stream (32), the table information of the second stream being generated for the selected program with an increased repetition rate in comparison with an incoming repetition rate of the table information in the first stream (30), at least temporarily during an initial time interval following a change of selection of the selected program.
